(19) United States
(12) Patent Application Publication
(10) Pub. No.: US 2007/0179910 A1
(43) Pub. Date: Aug. 2, 2007

(54) Method and apparatus for monitoring a postage meter

(76) Inventor: Mark Ferraro, Hamden, CT (US)

Correspondence Address: Kenyon & Kenyon LLP, 1500 K Street, NW, Washington, DC, 20005-1257, US

(21) Appl. No.: 11/343,318

(22) Filed: Jan. 31, 2006

(51) Int. Cl. G06F 17/00

(52) U.S. Cl. 705/401

(57) ABSTRACT

A franking module is provided which allows the postal customer to apply indicia to an item of mail, the indicia including an indication of the current value of postage available in postage meter. The indicia would be read and the available postage value would be accessible by a third party service provider.

### BACKGROUND OF THE INVENTION

1. Field of the Invention

The present invention relates to postage indicia printed on mail items and more particularly, to use of such postal indicia as a means to monitor account status of postage meter.

2. Brief Description of Related Developments

Postage meters have been utilized over a long period to print postage indicia on mail items. The postage indicia indicates that postage has been applied to the mail item and that accounting has been effected in respect of the applied postage. Conventionally the postal meter can be leased or rented from commercial enterprises set up for that purpose. Known postage meters include an electronic circuit for carrying out accounting functions in relation to amounts of postage charges applied to mail items. The electronic circuit receives an input of a desired postage charge to be applied to a mail item, carries out accounting in respect of the required postage charge and then operates a printer of the postage meter to print postage indicia on the mail item. Generally the postage indicia include at least the postage charge, the date on which the indicia is printed and an identification of the postage meter. A descending register is maintained within the postage meter to track account usage and postage value remaining.

Modern postage meters are provided with a digital printer that is controlled by the electronic circuit of the postage meter to print complete indicia. Due to the increased flexibility and capability of digital printers, it is possible to print additional information in the indicia which can be utilized to provide new and useful information.

As part of the use of postal meters, there is a need for updating postal information, such as rate changes and the like as well as current funding status. Currently the operation of a postage meter is interrupted in order to allow communication with the meter to or from a remote service provider. The main purpose of this is to obtain an up to date accounting of the current funding balance of a particular meter and if needed to replenish the value available. Such monitoring communications necessarily are periodic and result in gaps of information as to the day to day funding balance. Currently periods of 100 days is common. The total current value of a particular meter is therefore not instantaneously available. It is a purpose of this invention to provide a means by which the current funding value may be more readily available. Current funding value is especially important for both the user and the service provider upon a break down of the meter. Since the value present at the time the meter ceased operation needs to be reimbursed, it is important to accurately establish the amount lost.

### SUMMARY OF THE INVENTION

In the system of this invention a franking module is provided which allows the application of postal indicia to an item of mail. This indicia can take many forms, as long as it provides a secure means for authorizing postal transactions and is readable by a scanner at the post office. The indicia would include item specific data for example type of delivery, i.e. overnight, priority, first class and the like, place of origin, and document and source identification. The identification data would also include a customer account number and postage meter identifier registered at the post office. Software resident at the postal meter will also provide a coded status of the descending register of the postage meter from which the item is sent. The indicia, including the descending register balance, would be read and stored at the post office processor for access by the service provider. The current funding balance of a particular postage meter is thereby made available more frequently without service interruption. An appropriate communication link is provided with secured identifiers to provide the necessary access to the data base in which the descending register information is stored.

Other information contained on the indicia can be simple or complex, but should include customer ID, postage meter ID, mail item identification for tracking, as well as the item postage charge.

The system consists of a franking module and a scanner/reader at the post office which is designed to receive the indicia applied by the franking module. A processing module remote from the meter and preferably centrally located for example at the Post Office, checks the identification and stores the meter funding balance in a data base that may be searched by meter indentifier in association with authentication codes for security.

A system according to this invention, will minimize the need to interrupt meter use in order to update account information and providing a running record of the postage value available at a particular postage meter. Current account information is essential to establish a meters value in the event the meter ceases to function.

### BRIEF DESCRIPTION OF THE DRAWINGS

The foregoing aspects and other features of the present invention are explained in more detail below with reference to the following drawing in which:

FIG. 1 is a block diagram of a postage meter according to this invention;

FIG. 2 is a block diagram of a postal system according to this invention; and

FIG. 3 is a flow diagram of the method of this invention.

### DETAILED DESCRIPTION OF THE PREFERRED EMBODIMENTS

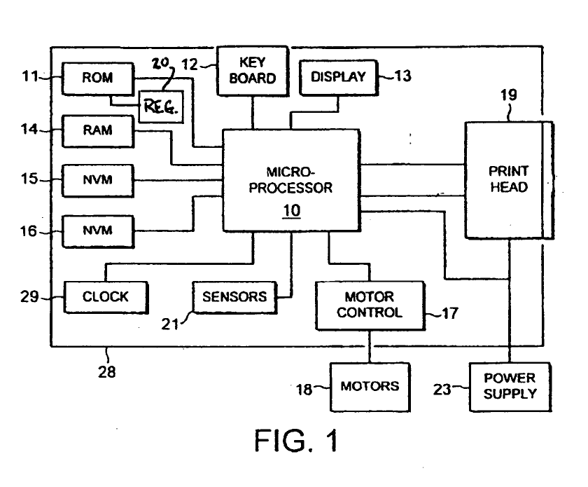

Referring first to FIG. 1 of the drawings, a typical postage meter (franking module) 1 includes a controller that comprises a micro-processor 10 operating under program routines stored in a read only memory (ROM) 11. A keyboard 12 is provided for input of commands and data by a user and a display 13 is provided to enable display of information to the user. A random access memory (RAM) 14 is provided for use as a working store for storage of temporary data during operation of the postage meter. Non-volatile duplicative memories 15 and 16 may be provided for the storage of critical data relating to use of the franking module and which is required to be retained even when the postage meter is not powered.

The microprocessor 10 carries out functions in relation to use of the postage meter for franking mail items with postal indicia relating to the authentication and billing for mail items received by the postal authority or other carriers. According to this invention the data incorporated into the indicia will further include a unique identifier code for each postal customer, a postage meter identifier, an a reading of the current status of the funding available in a particular postage meter. In addition the indicia data may include item specific information with respect to the postal mode and rate to be used, the point of origin, and an item identifier and other desired information.

Historical data relating to use of the franking module and any other critical data is retained in the non-volatile memories 15, 16. These data may include an accumulated total count of the number of mail items franked by the module and information relating to the printing of a unique user identifier for authentication. In addition accounting data that records postage value used by the franking module, is stored in a descending register 20 which may be part of ROM 11. In operation the register 20 records the renewed postage value applied to the postage meter when it is updated. The register 20 then counts down from the stored value until the amount is near depletion, whereupon an amount is restored by the provider.

Depending on the size of the module, a motor controller 17 may be connected to the microprocessor 10 to control operation of motors 18, which drive feeding means (not shown) for feeding a mail item past a digital print head 19. The digital print head 19 may be any form of digital print head. Sensors 21 are provided to sense and monitor feeding of the mail item. The sensors provide signals to the microprocessor to enable the microprocessor to control feeding of the mail item and to energize selectively print head 19 as the mail item is fed past the print head.

It will be appreciated, as is well known in the postage meter art, that the franking module 1 must operate in a secure manner and be protected from attempts to use it fraudulently, for example by imprinting the unique user identifier without authorization. Accordingly the franking module is housed in a secure housing 28. Access to the franking module 1 may be controlled by keying in a unique passage word, personal identification number (PIN) or both.

Each time a franking operation is to be performed by the postage meter/franking module, the micro-processor carries out a routine in which a determination is made as to whether the operation is authorized. This may be accomplished by using any number of computer security routines, such as those used at ATMs and other computer controlled stations. If proper identification of the user cannot be made the transaction is terminated and the franking indicia is not printed.

The indicia printed on the mail item are in a machine readable form and includes encrypted authentication data. Such data at a minimum will include a user identification which is correlated to an account number and other coded information to protect against unauthorized use. The encrypted authentication data information is printed on the mail item with the item specific information relating to point of origin, mode of postal service, item identification.

According to this invention, a software routine generates an indication of the current reading of the descending register 20 and includes this indication as part of the indicia printed on the mail item. This reading may be in coded form and is applicable only to the originating postage meter. The system of this invention provides a feed back loop that reveals, on a relatively continuous basis, the current value of the postage available. This allows the value to be reliably established in the event of a malfunction or permanent break down.

To facilitate the recording of the indicia data, the data is of a form which is machine readable. Accordingly the mail items received at the postal service prior to delivery, can be fed through reading means to scan the indicia on the mail items and computing means coupled to the reading means carries out verification checks on the scanned indicia and stores, including, among other things, the current status of the descending register 20 of the postage meter 1.

Conveniently postage data, encrypted authentication data, and account status data are printed in a form suitable for optical character recognition. In addition to the machine readable information, the indicia may contain information in human readable form. A compatible software routine is stored in the postal system server 6 and executes to cause the postal system server to store the current funding status reading from a postage meter in a data base that may be accessed by a service provider, such as a postage meter manufacturer or lessor by means of a communication link 5. Similarly a service provider would be provided with a complimentary software package that provides the functionality to access and obtain the stored funding status value for a particular postage meter, thereby reducing the memory of the postal server that might otherwise be provided.

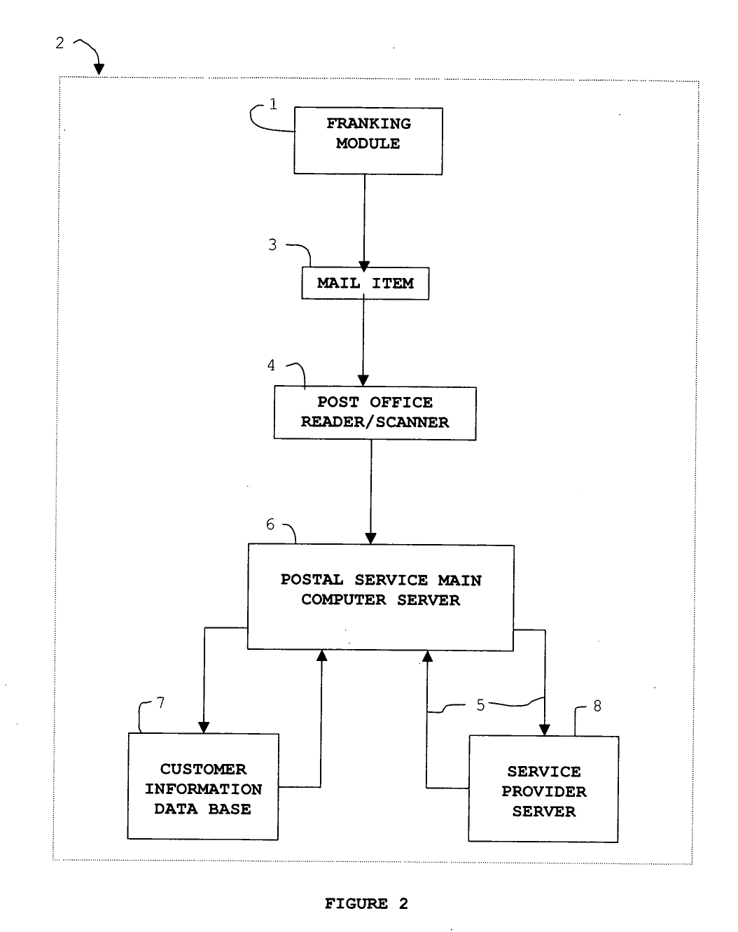

The franking system 2 of this invention, in which the franking module 1 is incorporated, is shown in FIG. 2. Mail items 3 processed in franking module 1 and marked with identification and accounting data, as described above, are presented to a scanner or reader 4 at a post office location. Data, scanned in readers 4, are sent by cable, fiber optics, wireless communication or similar connection means to a central postal computer server 6. Server 6 has access to customer information data base 7 which contains listings of customer identification data, authentication codes, and postage meter identifiers. By comparison of the identification data received from the scanned mail item to the data from the customer information data base 7, authorized use of the franking module 1 can be verified. The current status reading of the descending register of the originating postage meter will be stored in a data base according to its particular identifiers. The storage algorithm may be executed to store only the current funding value for a particular postage meter.

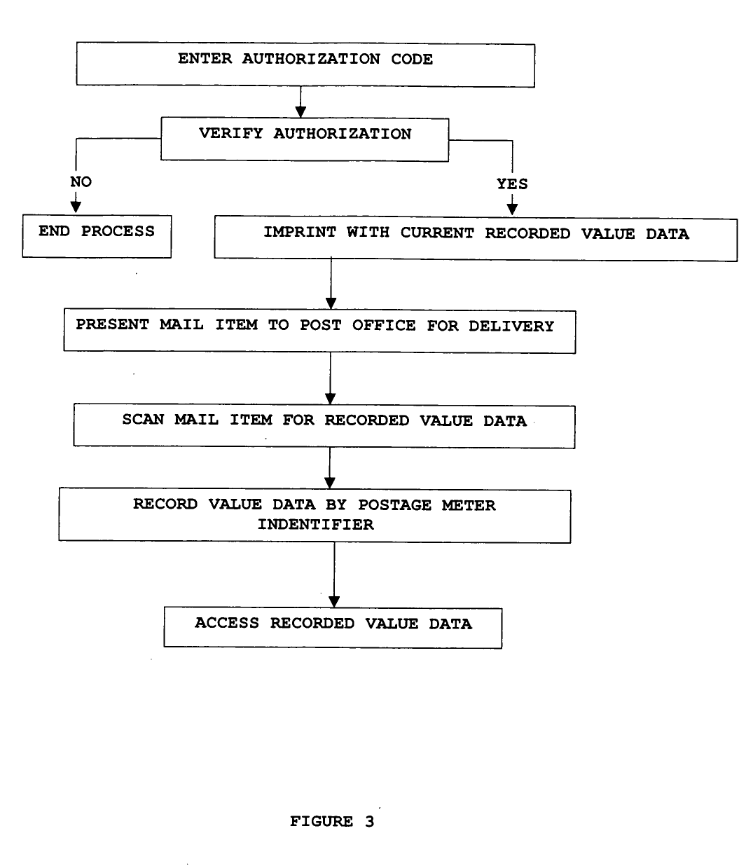

The operation the system of this invention is shown in FIG. 3. An item of mail 3 is fed into the franking module 1 either directly to the printer 20, or to an appropriate feed mechanism 18. Operation of the franking module 1 is initiated by means of an authorization code which is entered by the customer using keypad 12 of the franking module 1. A security algorithm, executable in microprocessor 10, checks the code and either authorizes a printing operation or ends the process. If the microprocessor 10 verifies that the user is authorized, the printer is energized to apply identification indicia to the mail item 3. According to this invention, the current value indicated by the descending register 20 of the postage meter is obtained and processed for printing as part of the indicia. The mail item is then transported to a postal scanner and the indicia are read. The data obtained from the scanned indicia is sent to a central computer server where it is identified by means of appropriate algorithms that cause the decoding, if necessary of the indicia and the recording of the current value reading for the postage meter to the data base. This information is made available to the respective service provider through communication link 5.

In an alternative embodiment, depending upon the communication capabilities of the postal server, the algorithm may be designed to automatically forward the account status information directly to the service provider server for storage via a connection through communication link 5. This would avoid the necessity to maintain an appropriate data base at the postal server and provides a complete feed back loop to the service provider for the postage value data. Such a function would require that the applicable service provider and location be provided either as part of the customer data base or as part of the indicia.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

1. (canceled)

2. A franking system comprising:
a franking module constructed to apply postal indicia to a mail item, the module further comprising:
a control processor for controlling the application of postal indicia;
a memory for providing information for inclusion in the postal indicia;
a register within the memory for recording the current value of postage available in the franking module;
an algorithm for causing the current recorded value from the register to be included as part of the postal indicia; and
a printer for applying the indicia, including said current recorded value on said mail item;
a scanner at a location remote from said franking module and accessible by the customer for the presentation of a mail item thereto, said scanner reading said indicia on said mail item and transmitting the data read from said inidicia to a central processor; and
wherein said central processor executes an algorithm which causes the extraction of the current recorded value and the storage thereof in an accounting database for retrieval by a manufacturer, provider, or operator of the franking module.

3. A franking system according to claim 2 wherein the scanner is located at a postal service center.

4. A franking system according to claim 2, wherein the accounting database is accessible by providers over a communications link.

5. A franking system according to claim 2, wherein the central processor automatically downloads the current recorded value via a communications link.

6. A method of obtaining current data relating to the postage value available in a postage meter comprising the steps of:
generating and storing data including the current recorded value present in the postage meter;
processing said current recorded value for application as part of the postal indicia;
printing said postal indicia including said current recorded value on a mail item;
presenting said mail item for mailing at a postal center and reading the indicia;
processing and storing the current recorded value in an accessible memory at the postal center;
accessing the current recorded value from a remote server;
establishing a communication link between the postal center and a third party; and
automatically forwarding the current recorded value via the communications link.

7. (canceled)
